(19) United States
(12) Patent Application Publication
(10) Pub. No.: US 2025/0092236 A1
(43) Pub. Date: Mar. 20, 2025

(54) RUBBER COMPOSITION MANUFACTURING METHOD, TIRE MANUFACTURING METHOD, AND RUBBER COMPOSITION MANUFACTURING APPARATUS

(71) Applicant: Toyo Tire Corporation, Itami-shi (JP)

(72) Inventor: Sho Taniguchi, Itami-shi (JP)

(73) Assignee: Toyo Tire Corporation, Itami-shi (JP)

(21) Appl. No.: 18/822,635

(22) Filed: Sep. 3, 2024

(30) Foreign Application Priority Data
Sep. 19, 2023 (JP) 2023-151103

(51) Int. Cl. C08L 9/06; B60C 1/00

(52) U.S. Cl. CPC C08L 9/06; B60C 1/0016

(57) ABSTRACT

A rubber composition manufacturing method including an operation in which at least a rubber component, silica, and a silane coupling agent are fed into a kneader and kneaded in a kneading chamber, and an operation in which the first mixture formed by the operation in which kneading is performed in the kneading chamber is transferred to another kneading chamber and kneaded in the kneading chamber, in which compressed gas is delivered to the kneading chamber in the operation in which kneading is performed in the kneading chamber.

### BACKGROUND OF THE INVENTION

### Field of the Invention

The present invention relates to a rubber composition manufacturing method, a tire manufacturing method, and a rubber composition manufacturing apparatus.

### Description of the Related Art

Because silica which is employed as reinforcing filler in rubber possesses silanol groups, there is a tendency for flocculation to occur due to hydrogen bonding. It is therefore the case that silica cannot easily be satisfactorily dispersed. In particular, silica cannot easily be satisfactorily dispersed in situations such as when silica filler content is high, silica particle diameter is small, and so forth.

To decrease silica cohesive forces, use of silane coupling agent is known. Silane coupling agents can prevent flocculation of silica because they are capable of reacting with silica during kneading. Silane coupling agents can react with double bonds of rubber components, for example, during vulcanization, and thus can also bond silica to rubber components.

As a method for decreasing the cohesive force of silica, that is, as a method for increasing the degree of silica dispersion, it is known that kneading is performed under proportional integral differential control (hereinafter, sometimes referred to as “PID control”) of the rotational speed of the rotor to set the kneading temperature to a target temperature (see, for example, Patent Document 1). Specifically, it is known that the target temperature is set to 150° C., that is, to the temperature at which the reaction (hereinafter, sometimes referred to as “coupling reaction”) of silica with a silane coupling agent proceeds vigorously, and then kneading is performed.

There is also a method in which kneading is performed under PID control of the rotor while the ram is kept in a non-pressing state (see Patent Document 2). According to this method, it is possible to discharge volatile substances (for example, water and alcohols produced in the course of the coupling reaction) to the outside of the kneading chamber, and the coupling reaction can be thus efficiently conducted. Therefore, the cohesive force of silica can be further decreased.

In the methods described in Patent Documents 1 and 2, since kneading is performed under PID control of the rotor, the kneading time per kneading stage is longer compared to the case where kneading is performed without PID control. A kneading stage is the cycle from the feeding of material(s) into a kneader until the discharge of the material(s).

Meanwhile, a method is known in which a kneader provided with two kneading chambers is used (see, for example, Patent Document 3). In this method, kneading is performed in the first kneading chamber, then the mixture formed by the kneading is transferred to the second mixing chamber, and kneading is performed in the second kneading chamber so that the coupling reaction proceeds vigorously. According to this method, it is possible to perform kneading in the first kneading chamber and kneading in the second kneading chamber in parallel, and thus the production volume per unit time can be increased. In other words, the productivity can be improved.

### PRIOR ART DOCUMENTS

### Patent Documents

Patent Document 1: JP-A-2013-18890
Patent Document 2: JP-A-2021-102721
Patent Document 3: U.S. Pat. No. 6,828,361 B2

### SUMMARY OF THE INVENTION

In such a method using a kneader, there is room for improvement in terms of ability to achieve reduced heat generation and wear resistance, which are important properties of tires.

It is an object of the present invention to provide a rubber composition manufacturing method and a tire manufacturing method, which permit improvement in wear resistance and ability to achieve reduced heat generation in tires. It is also an object of the present invention to provide a rubber composition manufacturing apparatus.

A rubber composition manufacturing method of the present invention to solve this problem includes: an operation in which at least a rubber component, silica, and a silane coupling agent are fed into a kneader including a first kneading chamber, a first rotor rotatable in the first kneading chamber, a second kneading chamber downstream of the first kneading chamber, and a second rotor rotatable in the second kneading chamber and kneaded in the first kneading chamber; and an operation in which a first mixture formed by the operation in which kneading is performed in the first kneading chamber is transferred to the second kneading chamber and kneaded in the second kneading chamber, and in the method, compressed gas is delivered to the second kneading chamber in the operation in which kneading is performed in the second kneading chamber.

In the rubber composition manufacturing method of the present invention, a kneader including a first kneading chamber and a second kneading chamber downstream of the first kneading chamber is used, and thus it is possible to perform kneading in the first kneading chamber and kneading in the second kneading chamber in parallel. Therefore, the productivity can be improved compared to the case where a kneader having one kneading chamber (hereinafter, sometimes referred to as a “single machine”) is used. In other words, the production volume per unit time can be improved.

Moreover, in the operation in which the first mixture containing a rubber component, silica, and a silane coupling agent is kneaded in the second kneading chamber, by deliverying compressed gas to the second kneading chamber, volatile substances, for example, water and alcohols (specifically, alcohols produced in the course of the coupling reaction) can be discharged to the outside of the second kneading chamber. Therefore, slippage of the second rotor due to water can be reduced, the coupling reaction can be efficiently conducted, and the cohesive force of silica can be decreased. Therefore, it will be possible to increase the degree to which silica is dispersed. As a result, it will be possible to improve wear resistance and ability to achieve reduced heat generation in tires.

In the above-mentioned manufacturing method, a constitution is preferable in which the kneader further includes a hole constituting an opening in a wall face of the second kneading chamber, and the compressed gas is delivered to the second kneading chamber by way of the hole of the second kneading chamber when the compressed gas is delivered to the second kneading chamber.

In any of the above-mentioned manufacturing methods, a constitution is preferable in which the kneader further includes a hole constituting an opening in a wall face of a channel between the first kneading chamber and the second kneading chamber, and gas in the second kneading chamber is discharged at least by way of the hole of the channel at least while the compressed gas is delivered to the second kneading chamber.

According to this constitution, it is possible to discharge volatile substances (for example, water and/or alcohols) by way of the hole of the channel, and thus it is possible to conduct the coupling reaction more efficiently and to further decrease the cohesive force of silica. It will therefore be possible to even further improve wear resistance and ability to achieve reduced heat generation in tires.

In any of the above-mentioned manufacturing methods, a constitution is preferable in which the compressed gas is compressed air.

According to this constitution, it is possible to reduce the cost. This is because compressed air can be produced at low cost.

In any of the above-mentioned manufacturing methods, a constitution is preferable in which proportional integral differential control (hereinafter, sometimes referred to as “PID control”) of a rotational speed of the second rotor is performed to set a kneading temperature in the second kneading chamber to a target temperature in the operation in which kneading is performed in the second kneading chamber.

In a case where kneading is performed without performing any PID control of the second rotor (that is, in a case where kneading is performed at a constant rotational speed of the second rotor), it is conceivable that a given blended mixture might result in a situation in which the kneading temperature does not reach the temperature for the coupling reaction to proceed vigorously, and that another given blended mixture might result in a situation in which the kneading temperature is made to increase to a temperature not less than the temperature at which gel formation occurs vigorously.

In contrast, according to this constitution, by controlling the rotational speed of the second rotor by means of PID control, it is possible to stabilize the kneading temperature, and thus it is possible to suppress occurrence of gel formation and/or reduction in the degree to which the coupling reaction takes place.

A tire manufacturing method of the present invention includes: an operation in which any of the above-mentioned rubber composition manufacturing methods is used to prepare a rubber composition; and an operation in which the rubber composition is used to fabricate an unvulcanized tire.

A rubber composition manufacturing apparatus of the present invention includes: a kneader including a first kneading chamber, a first rotor rotatable in the first kneading chamber, a second kneading chamber downstream of the first kneading chamber, a second rotor rotatable in the second kneading chamber, and a hole constituting an opening in a wall face of the second kneading chamber; and a compressor that generates compressed gas to be delivered to the second kneading chamber through the hole of the second kneading chamber.

According to the rubber composition manufacturing apparatus of the present invention, compressed gas generated by the compressor can be delivered to the second kneading chamber through the hole of the second kneading chamber. Therefore, volatile substances (for example, water and/or alcohols) can be discharged to the outside of the second kneading chamber, and thus it is possible to conduct the coupling reaction efficiently and to decrease the cohesive force of silica. Therefore, it will be possible to increase the degree to which silica is dispersed. As a result, it will be possible to improve wear resistance and ability to achieve reduced heat generation in tires.

### BRIEF DESCRIPTION OF THE DRAWINGS

FIG. 1 is a conceptual diagram showing the constitution of a rubber composition manufacturing apparatus in the present embodiment.

### DETAILED DESCRIPTION OF THE PREFERRED EMBODIMENTS

Below, description is given with respect to embodiments of the present invention.

### <1. Rubber Composition Manufacturing Apparatus>

Description will first be given with respect to a rubber composition manufacturing apparatus, that is, kneading system, capable of being used in the present embodiment.

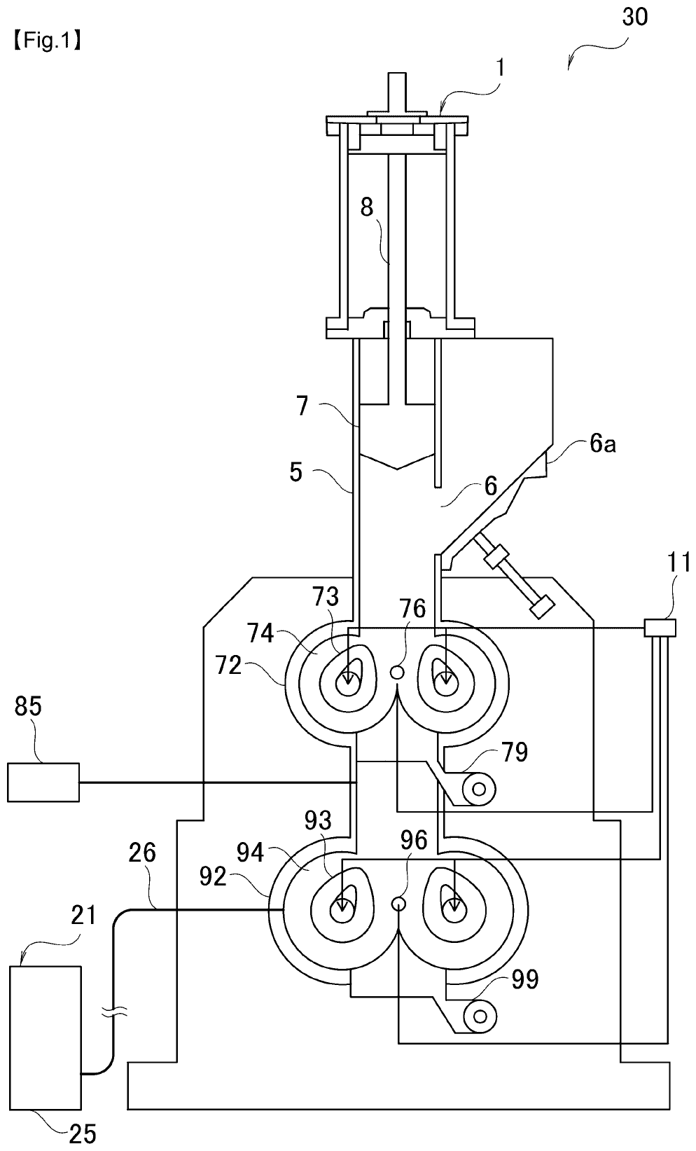

As shown in FIG. 1, rubber composition manufacturing apparatus 30 in the present embodiment includes kneader 1, and compressor 21 which generates compressed gas to be delivered to kneader 1. Manufacturing apparatus 30 further includes plumbing 26 which is for the compressed gas and which is secured to kneader 1. Regarding the path taken by the compressed gas, manufacturing apparatus 30 may include other equipment, for example, aftercooler(s), tank(s), mainlife filter(s), and/or air dryer(s), between compressor 21 and plumbing 26. Manufacturing apparatus 30 may, of course, include plumbing for connection thereof.

Manufacturing apparatus 30 further includes suction device 85 capable of sucking gas in kneader 1 (specifically, gas in kneading chamber 94 of kneader 1).

Compressor 21 may be capable of generating compressed gas. Compressor 21 includes housing 25. Within housing 25, compressor 21 might, for example, include: a motor (not shown); a compressor proper (not shown) which is driven by the motor and which compresses gas (for example, air); and a tank (not shown) which stores the compressed gas that is generated as a result of compression by the compressor proper. In such a compressor 21, compressed gas expelled from the compressor proper may flow into the tank by way of plumbing (not shown). On the other hand, compressed gas stored in the tank might be directed to the exterior of compressor 21 by way of plumbing (not shown). Note that compressor 21 might, for example, further include aftercooler(s), tank(s), mainlife filter(s), and/or air dryer(s).

As the compressed gas, compressed air and compressed inert gases (for example, nitrogen gas, helium gas, neon gas, and argon gas) may be cited as examples. Of these, because it can be generated at low cost, compressed air is preferred.

Compressed gas directed to the exterior of compressor 21 might, as necessary, be routed through aftercooler(s), tank(s), mainlife filter(s), and/or air dryer(s), and be routed through plumbing 26, to be delivered to kneading chamber 94 of kneader 1. Note that plumbing 26 is provided with a pressure gauge (not shown) for measuring the pressure of the compressed gas.

Kneader 1 includes kneading chamber 74, rotor 73 rotatable in kneading chamber 74, cylindrical neck 5 located above kneading chamber 74, inlet port 6 provided in neck 5, ram 7 movable up and down in the space inside neck 5, kneading chamber 94 downstream of kneading chamber 74, and rotor 93 rotatable in kneading chamber 94.

Casing 72 forming kneading chamber 74 is provided with an inlet and an outlet below the inlet. Kneading chamber 74 communicates with the space inside the neck 5 through the inlet. Meanwhile, kneading chamber 74 communicates with the channel, that is, the space between kneading chamber 74 and kneading chamber 94 through the outlet.

Kneader 1 includes a pair of rotors 73 that are rotatable in casing 72. The pair of rotors 73 may be of an intermeshing type or of a tangential type.

Kneader 1 further includes drop door 79 that can open and close the outlet of casing 72.

Inlet port 6, through which rubber components and compounding ingredients can be fed, is provided at the side face of neck 5. Two or more inlet ports 6 may be provided.

Kneader 1 may include hopper door 6a that can open and close inlet port 6.

Ram 7 is shaped as to be capable of closing off the inlet of casing 72. By virtue of shaft 8 which is connected thereto at the top end thereof, ram 7 is made capable of moving vertically within the space inside neck 5. Under the force of its own weight and/or as a result of a pressing force that acts thereon from shaft 8, ram 7 is able to press the rubber components and compounding ingredients that are present in casing 72. In other words, ram 7 is able to compress the materials.

Kneader 1 has a channel between casing 72 and casing 92 downstream of casing 72. In other words, kneader 1 is provided with a channel connecting kneading chamber 74 and kneading chamber 94.

Kneader 1 is provided with a hole constituting an opening in the wall face of the channel. Through this hole, the gas in kneading chamber 94 is sucked in by suction device 85 and discharged. In a case where suction device 85 is not used as well, gas in kneading chamber 94 is discharged through this hole.

Kneader 1 includes casing 92 below casing 72.

Therefore, kneader 1 is provided with kneading chamber 94 below kneading chamber 74. Casing 92 forming kneading chamber 94 is provided with an inlet and an outlet below the inlet. Through the inlet, kneading chamber 94 communicates with the channel (that is, the space connecting kneading chamber 74 and kneading chamber 94).

The capacity of kneading chamber 94 is larger than the capacity of kneading chamber 74. The capacity of kneading chamber 94 is larger than the capacity of kneading chamber 74 preferably by 20% or more and 60% or less.

Kneader 1 includes a hole constituting an opening in the wall face of kneading chamber 94. In other words, casing 92 of kneader 1 includes a hole constituting an opening which is directed toward kneading chamber 94. This hole passes all the way therethrough from the outer face of casing 92 to the inner face thereof. Compressed gas generated by compressor 21 is delivered to kneading chamber 94 by way of this hole.

Kneader 1 includes a pair of rotors 93 that are rotatable in casing 92. The pair of rotors 93 may be of an intermeshing type or of a tangential type.

Kneader 1 further includes drop door 99 that can open and close the outlet of casing 92.

The rotational speed of a motor (not shown) which causes rotor 73 to rotate is adjusted based on control signals from controller 11. Controller 11 carries out control of the rotational speed of the motor based on information (specifically, measured temperature Tp) regarding the temperature in kneading chamber 74 which is sent thereto from temperature sensor 76. The motor can be made to be of variable rotational speed by virtue of controller 11. The motor might, for example, be an inverter-duty motor.

To determine the rotational speed of the motor, a PID arithmetic unit provided inside controller 11 carries out proportional (P), integral (I), and differential (D) arithmetic operations based on the deviation between target temperature Ts and temperature Tp measured within kneading chamber 74 as detected by temperature sensor 76. More specifically, the PID arithmetic unit determines motor rotational speed from the sum of respective control quantities obtained as a result of proportional (P) action by which a control quantity is calculated in proportion to the difference (deviation e) between measured temperature Tp and target temperature Ts, integral (I) action by which a control quantity is calculated from an integral obtained by integrating the deviation e over time, and differential (D) action by which a control quantity is calculated from the slope of the change in, that is, the derivative of, deviation e. Note that PID is an abbreviation for Proportional Integral Differential.

The rotational speed of a motor (not shown) which causes rotor 93 to rotate is also adjusted based on control signals from controller 11. Controller 11 carries out control of the rotational speed of the motor based on information (specifically, measured temperature Tp) regarding the temperature within kneading chamber 94 which is sent thereto from temperature sensor 96. The motor can be made to be of variable rotational speed by virtue of controller 11. The motor might, for example, be an inverter-duty motor.

To determine the rotational speed of the motor, a PID arithmetic unit provided inside controller 11 carries out proportional (P), integral (I), and differential (D) arithmetic operations based on the deviation between target temperature Ts and temperature Tp measured within kneading chamber 94 as detected by temperature sensor 96. More specifically, the PID arithmetic unit determines motor rotational speed from the sum of respective control quantities obtained as a result of proportional (P) action by which a control quantity is calculated in proportion to the difference (deviation e) between measured temperature Tp and target temperature Ts, integral (I) action by which a control quantity is calculated from an integral obtained by integrating the deviation e over time, and differential (D) action by which a control quantity is calculated from the slope of the change in, that is, the derivative of, deviation e.

In kneader 1, the rubber components and compounding ingredients fed through inlet port 6 are pass through neck 5 into casing 72, that is, into kneading chamber 74, and kneaded in kneading chamber 74. In kneading chamber 74, the rubber components and compounding ingredients can be kneaded in a state of being pressed by ram 7, that is, under pressure. The first mixture formed in kneading chamber 74 passes through the channel into casing 92, that is, into kneading chamber 94, and kneaded in kneading chamber 94. Ram 7 does not reach the first mixture in kneading chamber 94, and therefore the mixture is kneaded without pressure.

### <2. Rubber Composition Manufacturing Method>

A rubber composition manufacturing method in the present embodiment will now be described.

The rubber composition manufacturing method in the present embodiment includes an operation (hereinafter “Operation S1”) in which a rubber mixture is prepared; and an operation (hereinafter “Operation S2”) in which at least the rubber mixture and a vulcanizing-type compounding ingredient are kneaded to obtain a rubber composition.

<2.1 Operation S1 (Operation in which Rubber Mixture is Prepared)>

Operation S1 includes an operation (hereinafter referred to as “Operation K1”) in which at least a rubber component, silica, and a silane coupling agent are fed into kneader 1 and kneaded in kneading chamber 74; and an operation (hereinafter referred to as “Operation K2”) in which the first mixture formed by Operation K1 is transferred to kneading chamber 94 and kneaded in kneading chamber 94. In the present embodiment, since kneader 1 is used, kneading in kneading chamber 74 and kneading in kneading chamber 94 can be performed in parallel. Therefore, the productivity can be improved compared to the case where a single machine is used. In other words, the production volume per unit time can be improved.

Operations K1 and K2 constitute one kneading stage. A kneading stage is the cycle from the feeding of material(s) into kneader 1 until the discharge of the material(s) to the outside of kneader 1.

<2.1.1. Operation K1 (Operation in which Kneading is Performed in Kneading Chamber 74)>

In Operation K1, at least a rubber component, silica, and a silane coupling agent are fed into kneader 1, and at least the rubber component, silica, and silane coupling agent are kneaded in kneading chamber 74.

As the rubber component, natural rubber, polyisoprene rubber, styrene-butadiene rubber (SBR), polybutadiene rubber (BR), nitrile rubber, chloroprene rubber, and so forth may be cited as examples. One or any desired combination may be chosen from thereamong and used. It is preferred that the rubber component be diene-based rubber.

Modified rubber may be used as the rubber component. As modified rubber, modified SBR and modified BR may be cited as examples. The modified rubber may possess functional group(s) that contain heteroatom(s). While functional group(s) may be introduced at end(s) of polymer chain(s) or in mid-chain, it is preferred that they be introduced at end(s) thereof. As functional group(s), amino groups, alkoxyl groups, hydroxyl groups, carboxyl groups, epoxy groups, cyano groups, halogen atoms, and so forth may be cited as examples. Among these, amino groups, alkoxyl groups, hydroxyl groups, and carboxyl groups are preferred. The modified rubber may possess at least one of the types of functional groups that were cited as examples. As amino group(s), primary amino groups, secondary amino groups, tertiary amino groups, and so forth may be cited as examples. As alkoxyl group(s), methoxy groups, ethoxy groups, propoxy groups, butoxy groups, and so forth may be cited as examples. The functional groups that were cited as examples interact with silanol groups (Si—OH) of silica. Here, “interaction” means, for example, that there is formation of a hydrogen bond or a chemical bond caused by chemical reaction with a silanol group of silica. The amount of modified rubber might be not less than 10% by mass, might be not less than 20% by mass, or might be not less than 30% by mass, per 100% by mass of the rubber component used in Operation K1. The amount of modified rubber might be not greater than 90% by mass, might be not greater than 80% by mass, or might be not greater than 70% by mass, per 100% by mass of the rubber component used in Operation K1.

As silica, wet silica and dry silica may be cited as examples. Among these, wet silica is preferred. As wet silica, precipitated silica may be cited as example. Specific surface area of silica as determined by nitrogen adsorption might be not less than 80 m²/g, or it might be not less than 120 m²/g, or it might be not less than 140 m²/g, or it might be not less than 160 m²/g, for example. Specific surface area of silica might be not greater than 300 m²/g, or it might be not greater than 280 m²/g, or it might be not greater than 260 m²/g, or it might be not greater than 250 m²/g, for example. Here, the specific surface area of silica is measured in accordance with the multipoint nitrogen adsorption method (BET method) described at JIS K-6430.

It is preferred in Operation K1 that the amount of silica be not less than 10 parts by mass, more preferred that this be not less than 30 parts by mass, still more preferred that this be not less than 50 parts by mass, still more preferred that this be not less than 70 parts by mass, and still more preferred that this be not less than 80 parts by mass, per 100 parts by mass of the rubber component. It is preferred that the amount of silica be not greater than 150 parts by mass, more preferred that this be not greater than 140 parts by mass, still more preferred that this be not greater than 130 parts by mass, and still more preferred that this be not greater than 120 parts by mass, per 100 parts by mass of the rubber component.

As the silane coupling agent, a sulfur-containing silane coupling agent may be cited. For example, bis(3-triethoxysilylpropyl) tetrasulfide, bis(3-triethoxysilylpropyl) disulfide, bis(2-triethoxysilylethyl)tetrasulfide, bis(4-triekitoshisilylbutyl)disulfide, bis(3-trimethoxysilylpropyl) tetrasulfide, bis(2-trimethoxysilylethyl)disulfide, and other such sulfide silanes, γ-mercaptopropyltrimethoxysilane, γ-mercaptopropyltriethoxysilane, mercaptopropylmethyldimethoxysilane, mercaptopropyldimethylmethoxysilane, mercaptoethyltriethoxysilane, and other such mercaptosilanes, 3-octanoylthio-1-propyltriethoxysilane, 3-propionylthiopropyltrimethoxysilane, and other such protected mercaptosilanes may be cited. One or any desired combination may be chosen from thereamong and used.

In Operation K1, it is preferred that the amount of silane coupling agent be not less than 1 part by mass, more preferred that this be not less than 3 parts by mass, and still more preferred that this be not less than 5 parts by mass, per 100 parts by mass of silica. The upper limit of the range in values for the amount of silane coupling agent might be 20 parts by mass, or might be 15 parts by mass, per 100 parts by mass of silica, for example.

In Operation K1, carbon black, antioxidant, stearic acid, wax, zinc oxide, oil, and/or the like may be kneaded together with the rubber component, silica, and silane coupling agent. One or any desired combination may be chosen from thereamong and used.

As examples of carbon black, besides SAF, ISAF, HAF, FEF, GPF, and/or other such furnace blacks, acetylene black, Ketchen black, and/or other such electrically conductive carbon blacks may be used. The carbon black may be nongranulated carbon black or may be granulated carbon black that has been granulated based upon considerations related to the handling characteristics thereof. Any one thereamong may be used, or any two or more thereamong may be used.

As antioxidant, aromatic-amine-type antioxidant, amine-ketone-type antioxidant, monophenol-type antioxidant, bisphenol-type antioxidant, polyphenol-type antioxidant, dithiocarbamate-type antioxidant, thiourea-type antioxidant, and the like may be cited as examples. One or any desired combination may be chosen from thereamong and used as the antioxidant.

In Operation K1, PID control of the rotational speed of rotor 73 may be performed. Specifically, PID control of the rotational speed of rotor 73 may be performed to adjust the kneading temperature in kneading chamber 74, that is, measured temperature Tp, to target temperature Ts. PID control may commence at the start of kneading in kneading chamber 74, or may commence when measured temperature Tp reaches a prescribed temperature (for example, target temperature Ts, or a temperature somewhat lower than target temperature Ts).

Target temperature Ts might be not less than 100° C., or might be not less than 120° C., or might be not less than 130° C., or might be not less than 140° C., or might be not less than 145° C., for example. Target temperature Ts might be not greater than 160° C., might be not greater than 155° C., or might be not greater than 150° C., for example.

The PID control may be performed for, for example, 10 seconds or more, 30 seconds or more, 60 seconds or more, 80 seconds or more, or 100 seconds or more. The PID control may be performed for, for example, 1000 seconds or less, 800 seconds or less, 600 seconds or less, 400 seconds or less, or 200 seconds or less.

In Operation K1, compressed gas is not delivered to kneading chamber 74.

<2.1.2. Operation K2 (Operation in which Kneading is Performed in Kneading Chamber 94)>

In Operation K2, the first mixture formed in Operation K1 is transferred to kneading chamber 94 and kneaded in kneading chamber 94. To transfer the first mixture to kneading chamber 94, drop door 79 can be opened and the first mixture can be dropped into kneading chamber 94.

In Operation K2, compressed gas is delivered to kneading chamber 94. In other words, while the first mixture is kneaded in kneading chamber 94, compressed gas is delivered to kneading chamber 94. By delivering compressed gas into kneading chamber 94, volatile substances, for example, water and alcohols (specifically, alcohols produced in the course of the coupling reaction) can be discharged to the outside of kneading chamber 94. Therefore, slippage of rotor 93 due to water can be reduced, the coupling reaction can be efficiently conducted, and the cohesive force of silica can be decreased. Therefore, it will be possible to increase the degree to which silica is dispersed. As a result, it will be possible to improve wear resistance and ability to achieve reduced heat generation in tires.

By delivering compressed gas into kneading chamber 94 in Operation K2, it is also possible to avoid loss of silica. Description will be given with respect to this. If compressed gas is delivered to kneading chamber 74 in Operation K1 instead of delivering compressed gas into kneading chamber 94 in Operation K2, the delivery of compressed gas may cause the silica to scatter. This is because silica is not yet sufficiently incorporated into the rubber component in kneading chamber 74. In contrast, in the present embodiment, compressed gas is delivered to kneading chamber 94 in Operation K2. In other words, compressed gas is delivered when the first mixture in which silica has been sufficiently or to some extent incorporated into the rubber component is kneaded. Therefore, scattering of silica can be suppressed. Consequently, the loss of silica can be avoided.

When compressed gas is delivered to kneading chamber 94, the compressed gas is delivered to kneading chamber 94 by way of the hole of kneading chamber 94 (specifically, the hole constituting an opening in the wall face of kneading chamber 94).

The compressed gas may be delivered unceasingly, that is, continuously or intermittently. Among these, the compressed gas is preferably delivered unceasingly, that is, continuously.

Kneading while the compressed gas is delivered, that is, kneading under the compressed gas may be carried out all throughout Operation K2 or for only a portion of the time during which Operation K2 is being carried out. In a case where kneading under compressed gas is performed in the middle of Operation K2, the kneading under compressed gas may be started, for example, 10 seconds or more, 20 seconds or more, or 30 seconds or more after the start of Operation K2.

The kneading under compressed gas is performed for preferably 10 seconds or more, more preferably 20 seconds or more, still more preferably 30 seconds or more. The kneading under the compressed gas may be performed for 60 seconds or more, 120 seconds or more, or 180 seconds or more. In a case where the compressed gas is delivered intermittently, the time of kneading under compressed gas is the total time during which the compressed gas is delivered.

Pressure of the compressed gas delivered to kneading chamber 94 might be not less than 0.2 MPa, or might be not less than 0.3 MPa, or might be not less than 0.4 MPa. When this is not less than 0.2 MPa, it will be possible to cause volatile substances (for example, water and/or alcohols) to be more effectively discharged to the outside of kneading chamber 94. Note that “pressure of the compressed gas” may be taken to be the pressure of the compressed gas within plumbing 26. This pressure might be measured by means of a pressure gauge provided at plumbing 26.

The amount of compressed gas which is expelled therefrom (specifically, the amount of compressed gas expelled from compressor 21) might be not less than 300 L/min, or might be not less than 700 L/min, for example. Meanwhile, the amount expelled therefrom might be not greater than 1500 L/min, or might be not greater than 1200 L/min, or might be not greater than 1000 L/min, for example.

The temperature of compressed gas delivered to kneading chamber 94 might be not less than 15° C., or might be not less than 20° C., or might be not less than 25° C., for example. Meanwhile, the temperature of compressed gas might be not greater than 160° C., might be not greater than 150° C., or might be not greater than 100° C., for example. Note that “the temperature of the compressed gas” might be the temperature of the compressed gas which emerges from an air dryer, for example. What is referred to here as an air dryer might be an air dryer which is incorporated within compressor 21, or might be an air dryer which is provided between compressor 21 and kneader 1.

While the compressed gas is delivered to kneading chamber 94, the gas in kneading chamber 94 is discharged by way of the hole of the channel. At this time, through this hole, the gas in kneading chamber 94 may be sucked in by suction device 85. In other words, suction may be performed for the purpose of discharge. Meanwhile, the gas in kneading chamber 94 may be discharged by way of this hole without suction. With or without suction, the gas in kneading chamber 94 may be discharged by way of the hole of the channel as well as by way of other holes.

In Operation K2, PID control of the rotational speed of rotor 93 may be performed. Specifically, PID control of the rotational speed of rotor 93 may be performed to adjust the kneading temperature in kneading chamber 94, that is, measured temperature Tp, to target temperature Ts. PID control may commence at the start of kneading in kneading chamber 94, or may commence when measured temperature Tp reaches a prescribed temperature (for example, target temperature Ts, or a temperature somewhat lower than target temperature Ts).

By controlling the rotational speed of rotor 93 by means of PID control, it is possible to stabilize the kneading temperature, this makes it possible to suppress occurrence of gel formation and/or reduction in the degree to which the coupling reaction takes place.

Target temperature Ts might be not less than 140° C., or might be not less than 142° C., or might be not less than 145° C., or might be not less than 148° C., or might be not less than 150° C., for example. When target temperature Ts is not less than 140° C., the coupling reaction tends to proceed vigorously. It is preferred that target temperature Ts be not greater than 170° C., more preferred that this be not greater than 165° C., still more preferred that this be not greater than 160° C., still more preferred that this be not greater than 155° C., and still more preferred that this be not greater than 153° C. When target temperature Ts is not greater than 170° C., gel formation tends to be suppressed.

The PID control may be performed for, for example, 10 seconds or more, 30 seconds or more, 60 seconds or more, 80 seconds or more, 100 seconds or more, or 120 seconds or more. The PID control may be performed for, for example, 1000 seconds or less, 800 seconds or less, 600 seconds or less, 500 seconds or less, 400 seconds or less, or 300 seconds or less.

In a case where PID control is performed, it is preferable to perform the delivery of compressed gas in parallel with the PID control. The compressed gas may be delivered throughout the time during which the PID control is performed, or only for a portion of the time during which the PID control is performed.

The rubber mixture formed by kneading in kneading chamber 94 can be discharged from kneading chamber 94 by opening drop door 99.

### <2.1.3. Miscellaneous>

Where necessary, the rubber mixture may be subjected to further kneading for improvement of silica dispersal characteristics and/or reduction in Mooney viscosity. In other words, rekneading thereof may be carried out. Rekneading may be carried out multiple times.

As a result of a procedure such as the foregoing, a rubber mixture may be obtained.

<2.2. Operation S2 (Operation in which Rubber Mixture and Vulcanizing-Type Compounding Ingredient Are Kneaded to Obtain Rubber Composition)>

In Operation S2, at least the rubber mixture and a vulcanizing-type compounding ingredient are kneaded to obtain a rubber composition. As examples of the vulcanizing-type compounding ingredient, sulfur, organic peroxides, and other such vulcanizing agents, vulcanization accelerators, vulcanization accelerator activators, vulcanization retarders, and so forth may be cited. One or any desired combination may be chosen from thereamong and used as the vulcanizing-type compounding ingredient. As examples of the sulfur, powdered sulfur, precipitated sulfur, insoluble sulfur, high dispersing sulfur, and the like may be cited. One or any desired combination may be chosen from thereamong and used as the sulfur. As examples of the vulcanization accelerators, sulfenamide-type vulcanization accelerators, thiuram-type vulcanization accelerators, thiazole-type vulcanization accelerators, thiourea-type vulcanization accelerators, guanidine-type vulcanization accelerators, dithiocarbamate-type vulcanization accelerators, and so forth may be cited. One or any desired combination may be chosen from thereamong and used as the vulcanization accelerator. Kneading may be carried out using a kneader. As the kneader, kneader 1, open rolls, Banbury mixers, kneaders, and the like may be cited as examples.

It is preferred that the amount of silica in the rubber composition be not less than 10 parts by mass, more preferred that this be not less than 30 parts by mass, still more preferred that this be not less than 50 parts by mass, still more preferred that this be not less than 70 parts by mass, and still more preferred that this be not less than 80 parts by mass, per 100 parts by mass of the rubber component. It is preferred that the amount of silica be not greater than 150 parts by mass, more preferred that this be not greater than 140 parts by mass, still more preferred that this be not greater than 130 parts by mass, and still more preferred that this be not greater than 120 parts by mass, per 100 parts by mass of the rubber component.

It is preferred that the amount of silane coupling agent in the rubber composition be not less than 1 part by mass, more preferred that this be not less than 3 parts by mass, and still more preferred that this be not less than 5 parts by mass, per 100 parts by mass of silica. The upper limit of the range in values for the amount of silane coupling agent might be 20 parts by mass, or might be 15 parts by mass, per 100 parts by mass of silica, for example.

The rubber composition may further include carbon black, antioxidant, stearic acid, wax, zinc oxide, oil, sulfur, vulcanization accelerator, and/or the like. The rubber composition may include one or any desired combination thereamong. It is preferred that the amount of sulfur, expressed as equivalent sulfur content, be 0.5 part by mass to 5 parts by mass per 100 parts by mass of the rubber component. It is preferred that the amount of vulcanization accelerator be 0.1 part by mass to 5 parts by mass per 100 parts by mass of the rubber component.

The rubber composition may be used to fabricate a tire. More specifically, it is capable of being used in fabricating tire member(s) making up a tire. For example, the rubber composition may be used in fabricating tread rubber, sidewall rubber, chafer rubber, bead filler rubber, and/or the like. The rubber composition may be used to fabricate one or any desired combination among such tire member(s).

### <3. Tire Manufacturing Method>

Methods for manufacturing tires in the present embodiment will now be described. Of the operations included by the tire manufacturing method of the present embodiment, note that operations for preparing a rubber composition have already been described.

A tire manufacturing method in the present embodiment includes an operation in which a rubber composition is used to fabricate an unvulcanized tire. This operation includes fabrication of tire member(s) that include a rubber composition(s), and fabrication of an unvulcanized tire that includes the tire member(s). As tire member(s), tread rubber, sidewall rubber, chafer rubber, and bead filler rubber may be cited as examples. Thereamong, tread rubber is preferred.

The tire manufacturing method in the present embodiment may further include an operation in which the unvulcanized tire is vulcanized and molded. The tire obtained by the method of the present embodiment may be a pneumatic tire.

### 4. Various Modifications May Be Made to the Foregoing Embodiment

Various modifications may be made to the foregoing embodiment. For example, modifications which may be made to the foregoing embodiment might include any one or more variations chosen from among the following.

The foregoing embodiment was described in terms of a constitution in which compressed gas is delivered to kneading chamber 94 by way of a hole constituting an opening in the wall face of kneading chamber 94. However, the foregoing embodiment is not limited to this constitution. For example, compressed gas may be delivered to kneading chamber 94 by way of a hole constituting an opening in the wall face of the channel. At this time, gas in kneading chamber 94 may be discharged by way of a hole constituting an opening in the wall face of kneading chamber 94.

The foregoing embodiment was described in terms of a constitution in which manufacturing apparatus 30 includes suction device 85. However, the foregoing embodiment is not limited to this constitution. In other words, manufacturing apparatus 30 may not include suction device 85.

The foregoing embodiment was described in terms of a constitution in which the gas in kneading chamber 94 is discharged by way of the hole of the channel. However, the foregoing embodiment is not limited to this constitution. For example, the gas in kneading chamber 94 may be discharged by way of inlet port 6 after hopper door 6a and drop door 79 are opened to some extent.

The foregoing embodiment was described in terms of a constitution in which compressed gas is not delivered to kneading chamber 74 when at least a rubber component, silica, and a silane coupling agent are kneaded in kneading chamber 74 in Operation K1. However, the foregoing embodiment is not limited to this constitution. In other words, compressed gas may be delivered to kneading chamber 74 in Operation K1 as well.

The foregoing embodiment was described in terms of a constitution in which kneader 1 is provided with kneading chamber 94 below kneading chamber 74. However, the foregoing embodiment is not limited to this constitution. For example, kneading chamber 94 may be provided at the same height as kneading chamber 74. In this case, kneader 1 may include a belt conveyor between kneading chamber 74 and kneading chamber 94 for transferring the first mixture formed in kneading chamber 74 to kneading chamber 94.

The foregoing embodiment was described in terms of a constitution in which kneader 1 including only kneading chamber 74 and kneading chamber 94 as the kneading chamber is used in Operations K1 and K2. However, the foregoing embodiment is not limited to this constitution. For example, kneader 1 may further include a third kneading chamber below kneading chamber 94.

The foregoing embodiment was described in terms of a constitution in which kneader 1 includes controller 11. However, the foregoing embodiment is not limited to this constitution. In other words, kneader 1 may not include controller 11.

The foregoing embodiment was described in terms of a constitution in which the total amount of silica is fed at the kneading stage including Operations K1 and K2. However, the foregoing embodiment is not limited to this constitution. For example, feeding of silica thereinto may be divided among a plurality of kneading stages.

The foregoing embodiment was described in terms of a constitution in which a rubber mixture and a vulcanizing-type compounding ingredient are kneaded to obtain a rubber composition. However, the foregoing embodiment is not limited to this constitution. For example, a rubber mixture may be treated as a rubber composition.

### EXAMPLES

Working examples of the present invention are described below.

### Comparative Examples 1 to 5 and Working Examples 1 to 7

The raw materials and reagents that were used at these Examples are indicated below.

SBR “SBR 1502” manufactured by JSR Corporation

Modified solution polymerization SBR “HPR 350” manufactured by JSR Corporation

Silica “Nipsil AQ” manufactured by Tosoh Silica Corporation

Silane coupling agent “Si 75” manufactured by Degussa

Stearic acid “LUNAC S-20” manufactured by Kao Corporation

Carbon black “N339 SEAST KH” manufactured by Tokai Carbon Co., Ltd.

Oil “PROCESS NC140” manufactured by ENEOS

Zinc oxide “Zinc Oxide No. 1” manufactured by Mitsui Mining & Smelting Co., Ltd.

Antioxidant “Antigen 6C” manufactured by manufactured by Sumitomo Chemical Co., Ltd.

Sulfur “5% Oil Treated Sulfur” manufactured by Tsurumi Chemical Industry Co., Ltd.

Vulcanization Accelerator 1 “Sanceler DM-G” manufactured by Sanshin Chemical Industry Co., Ltd.

Vulcanization Accelerator 2 “Soxinol CZ” manufactured by Sumitomo Chemical Co., Ltd.

TABLE 1

| | | First | |
|---|---|---|---|
| | | kneading | Final |
| | | stage | stage |
| Blending | SBR | 50.0 | — |
| parts by | Modified solution polymerization SBR | 50.0 | — |
| mass | Silica | 120.0 | — |
| | Silane coupling agent | 11.0 | — |
| | Stearic acid | 2.0 | — |
| | Carbon black | 5.0 | — |
| | Oil | 40.0 | — |
| | Zinc oxide | 2.0 | — |
| | Antioxidant | 2.0 | — |
| | Sulfur | — | 2.5 |
| | Vulcanization accelerator 1 | — | 2.5 |
| | Vulcanization accelerator 2 | — | 2.3 |

### Preparation of Unvulcanized Rubber in Comparative Example 1

### Single Machine Assumed Kneading

The rubber components and compounding ingredients according to TABLE 1 were fed into a tandem mixer (namely, a kneader having a structure similar to that of kneader 1 shown in FIG. 1), kneading was performed in the first mixer (namely, the upstream mixer; hereinafter, sometimes referred to as the “upper mixer”) without PID control, and the mixture was discharged (first kneading stage). The mixture obtained at the first kneading stage was rekneaded (second kneading stage). The mixture obtained at the second kneading stage was rekneaded (third kneading stage). The mixture obtained at the third kneading stage and sulfur and vulcanization accelerator were kneaded to obtain unvulcanized rubber (final stage).

### Preparation of Unvulcanized Rubber in Comparative Example 2

### Single Machine Assumed Kneading

The rubber components and compounding ingredients according to TABLE 1 were fed into a tandem mixer and kneaded using the upper mixer while PID control (specifically, PID control in which the control start temperature was 150° C., the target temperature was 150° C., and the control time was 360 seconds) was carried out, and the mixture was discharged (first kneading stage). The mixture obtained at the first kneading stage was rekneaded (second kneading stage). The mixture obtained at the second kneading stage and sulfur and a vulcanization accelerator were kneaded to obtain unvulcanized rubber (final stage).

### Preparation of Unvulcanized Rubber in Comparative Example 3

The rubber components and compounding ingredients according to TABLE 1 were fed into a tandem mixer, kneaded using the upper mixer without PID control, and kneaded using the lower mixer (namely, the second mixer) without PID control, and the mixture was discharged (first kneading stage). The mixture obtained at the first kneading stage was rekneaded (second kneading stage). The mixture obtained at the second kneading stage and sulfur and a vulcanization accelerator were kneaded to obtain unvulcanized rubber (final stage).

### Preparation of Unvulcanized Rubber in Comparative Example 4

The rubber components and compounding ingredients according to TABLE 1 were fed into a tandem mixer, kneaded using the upper mixer without PID control, and kneaded using the lower mixer while PID control (specifically, PID control in which the control start temperature was 150° C., the target temperature was 150° C., and the control time was 360 seconds) was carried out, and the mixture was discharged (first kneading stage). The mixture obtained at the first kneading stage was rekneaded (second kneading stage). The mixture obtained at the second kneading stage and sulfur and a vulcanization accelerator were kneaded to obtain unvulcanized rubber (final stage).

### Preparation of Unvulcanized Rubber in Comparative Example 5

The rubber components and compounding ingredients according to TABLE 1 were fed into a tandem mixer, kneaded using the upper mixer while PID control (specifically, PID control in which the control start temperature was 150° C., the target temperature was 150° C., and the control time was 130 seconds) was carried out, and kneaded using the lower mixer while PID control (specifically, PID control in which the control start temperature was 150° C., the target temperature was 150° C., and the control time was 230 seconds) was carried out, and the mixture was discharged (first kneading stage). The mixture obtained at the first kneading stage was rekneaded (second kneading stage). The mixture obtained at the second kneading stage and sulfur and a vulcanization accelerator were kneaded to obtain unvulcanized rubber (final stage).

### Preparation of Unvulcanized Rubber in Working Example 1

The rubber components and compounding ingredients according to TABLE 1 were fed into a tandem mixer, kneaded using the upper mixer without PID control, and kneaded using the lower mixer without PID control, and the mixture was discharged (first kneading stage). Regarding kneading using the lower mixer, compressed air generated by a compressor was delivered to the lower mixer by way of the hole formed in the wall face of the lower mixer only for 30 seconds from the time when the kneading temperature, namely, the measured temperature, reached 150° C. The mixture obtained at the first kneading stage was rekneaded (second kneading stage). The mixture obtained at the second kneading stage and sulfur and a vulcanization accelerator were kneaded to obtain unvulcanized rubber (final stage).

### Preparation of Unvulcanized Rubber in Working Example 2

The rubber components and compounding ingredients according to TABLE 1 were fed into a tandem mixer, kneaded using the upper mixer without PID control, and kneaded using the lower mixer while PID control (specifically, PID control in which the control start temperature was 150° C., the target temperature was 150° C., and the control time was 360 seconds) was carried out, and the mixture was discharged (first kneading stage). Regarding kneading using the lower mixer, compressed air generated by a compressor was delivered to the lower mixer by way of the hole formed in the wall face of the lower mixer from the start of control only for 30 seconds of the 360 seconds of control time. The mixture obtained at the first kneading stage was rekneaded (second kneading stage). The mixture obtained at the second kneading stage and sulfur and a vulcanization accelerator were kneaded to obtain unvulcanized rubber (final stage).

### Preparation of Unvulcanized Rubber in Working Example 3

The rubber components and compounding ingredients according to TABLE 1 were fed into a tandem mixer, kneaded using the upper mixer while PID control (specifically, PID control in which the control start temperature was 150° C., the target temperature was 150° C., and the control time was 130 seconds) was carried out, and kneaded using the lower mixer while PID control (specifically, PID control in which the control start temperature was 150° C., the target temperature was 150° C., and the control time was 230 seconds) was carried out, and the mixture was discharged (first kneading stage). Regarding kneading using the lower mixer, compressed air generated by a compressor was delivered to the lower mixer by way of the hole formed in the wall face of the lower mixer from the start of control only for 30 seconds of the 230 seconds of control time. The mixture obtained at the first kneading stage was rekneaded (second kneading stage). The mixture obtained at the second kneading stage and sulfur and a vulcanization accelerator were kneaded to obtain unvulcanized rubber (final stage).

### Preparation of Unvulcanized Rubber in Working Example 4

Unvulcanized rubber was prepared in the same manner as in Working Example 3, except that compressed air was delivered to the lower mixer from the start of control only for 80 seconds of the 230 seconds of control time regarding kneading using the lower mixer.

### Preparation of Unvulcanized Rubber in Working Example 5

Unvulcanized rubber was prepared in the same manner as in Working Example 3, except that compressed air was delivered to the lower mixer from the start of control only for 130 seconds of the 230 seconds of control time regarding kneading using the lower mixer.

### Preparation of Unvulcanized Rubber in Working Example 6

Unvulcanized rubber was prepared in the same manner as in Working Example 3, except that compressed air was delivered to the lower mixer from the start of control only for 180 seconds of the 230 seconds of control time regarding kneading using the lower mixer.

### Preparation of Unvulcanized Rubber in Working Example 7

Unvulcanized rubber was prepared in the same manner as in Working Example 3, except that compressed air was delivered to the lower mixer throughout the 230 seconds of control time regarding kneading using the lower mixer.

### Preparation of Vulcanized Rubber

The unvulcanized rubber was vulcanized for 30 minutes at 150° C. to obtain vulcanized rubber.

### Mooney Viscosity

A rotorless Mooney measurement apparatus manufactured by Toyo Seiki Seisaku-sho, Ltd., was used to measure Mooney viscosity of the unvulcanized rubber in accordance with JIS K-6300. To measure Mooney viscosity, unvulcanized rubber was preheated at 100° C. for 1 minute, following which the rotor was made to rotate, the value of the torque 4 minutes after the start of rotation of the rotor being recorded in Mooney units. The Mooney viscosities of the respective Examples are shown in TABLE 2 as indexed relative to a value of 100 for the Mooney viscosity obtained in Comparative Example 1. The smaller the index the lower the Mooney viscosity and the better the workability.

### Wear Resistance

The amount of wear of the vulcanized rubber was measured in accordance with JIS K6264 using a Lambourn abrasion tester with a load of 3 kg and a slip ratio of 20% at a temperature of 23° C. The reciprocals (reciprocals of amounts of wear) for the respective Examples are shown in TABLE 2 as indexed relative to a value of 100 for the reciprocal of the amount of wear obtained in Comparative Example 1. The higher the index the better the wear resistance.

### Wet Braking Performance

A Rupke rebound resilience testing apparatus was used to measure rebound resilience (%) under conditions of 23° C. in accordance with JIS K6255. The reciprocals (reciprocals of rebound resiliences) for the respective Examples are shown in TABLE 2 as indexed relative to a value of 100 for the reciprocal of the rebound resilience obtained in Comparative Example 1. The higher the index the better the wet braking performance.

### Ability to Achieve Reduced Fuel Consumption

A viscoelasticity testing machine manufactured by Toyo Seiki Seisaku-sho, Ltd., was used to measure tan δ of the vulcanized rubber in accordance with JIS K-6394. tan δ was measured under conditions of frequency 10 Hz, dynamic strain 1.0%, temperature 60° C., and static strain (initial strain) 10%. tan δ of the respective Examples are shown in TABLE 2 as indexed relative to a value of 100 for the tan δ obtained in Comparative Example 1. The smaller the index the lower the tan δ and the better the ability to achieve reduced fuel consumption.

TABLE 2

| | | Comparative | Comparative | Comparative | Comparative | Comparative | Working | Working | Working |
|---|---|---|---|---|---|---|---|---|---|
| | | Example 1 | Example 2 | Example 3 | Example 4 | Example 5 | Example 1 | Example 2 | Example 3 |
| First | Upper | — | 150 | — | — | 150 | — | — | 150 |
| kneading | mixer target | | | | | | | | |
| stage | temperature | | | | | | | | |
| | ° C. | | | | | | | | |
| | Lower | — | — | — | 150 | 150 | — | 150 | 150 |
| | mixer target | | | | | | | | |
| | temperature | | | | | | | | |
| | ° C. | | | | | | | | |
| | Upper | — | 360 | — | — | 130 | — | — | 130 |
| | mixer control | | | | | | | | |
| | time seconds | | | | | | | | |
| | Lower | — | — | — | 360 | 230 | — | 360 | 230 |
| | mixer control | | | | | | | | |
| | time seconds | | | | | | | | |
| | Compressed | Absence | Absence | Absence | Absence | Absence | Presence | Presence | Presence |
| | air injection | | | | | | | | |
| | Compressed | — | — | — | — | — | 30 | 30 | 30 |
| | air injection | | | | | | | | |
| | time seconds | | | | | | | | |
| | Discharge | 150 | 150 | 150 | 150 | 150 | 150 | 150 | 150 |
| | temperature | | | | | | | | |
| | ° C. | | | | | | | | |
| Second kneading | | Presence | Presence | Presence | Presence | Presence | Presence | Presence | Presence |
| stage (rekneading) | | | | | | | | | |
| Third kneading | | Presence | Absence | Absence | Absence | Absence | Absence | Absence | Absence |
| stage (rekneading) | | | | | | | | | |
| Eval- | Mooney | 100 | 102 | 100 | 101 | 101 | 98 | 97 | 99 |
| uation | viscosity | | | | | | | | |
| | Wear | 100 | 110 | 103 | 112 | 111 | 108 | 116 | 115 |
| | resistance | | | | | | | | |
| | Wet braking | 100 | 104 | 101 | 104 | 105 | 102 | 104 | 105 |
| | performance | | | | | | | | |
| | Ability | 100 | 93 | 98 | 92 | 92 | 94 | 89 | 90 |
| | to achieve | | | | | | | | |
| | reduced fuel | | | | | | | | |
| | consumption | | | | | | | | |

| | | Working | Working | Working | Working |
|---|---|---|---|---|---|
| | | Example 4 | Example 5 | Example 6 | Example 7 |
| First | Upper | 150 | 150 | 150 | 150 |
| kneading | mixer target | | | | |
| stage | temperature | | | | |
| | ° C. | | | | |
| | Lower | 150 | 150 | 150 | 150 |
| | mixer target | | | | |
| | temperature | | | | |
| | ° C. | | | | |
| | Upper | 130 | 130 | 130 | 130 |
| | mixer control | | | | |
| | time seconds | | | | |
| | Lower | 230 | 230 | 230 | 230 |
| | mixer control | | | | |
| | time seconds | | | | |
| | Compressed | Presence | Presence | Presence | Presence |
| | air injection | | | | |
| | Compressed | 80 | 130 | 180 | 230 |
| | air injection | | | | |
| | time seconds | | | | |
| | Discharge | 150 | 150 | 150 | 150 |
| | temperature | | | | |
| | ° C. | | | | |
| Second kneading | | Presence | Presence | Presence | Presence |
| stage (rekneading) | | | | | |
| Third kneading | | Absence | Absence | Absence | Absence |
| stage (rekneading) | | | | | |
| Eval- | Mooney | 100 | 97 | 97 | 94 |
| uation | viscosity | | | | |
| | Wear | 118 | 122 | 132 | 134 |
| | resistance | | | | |
| | Wet braking | 105 | 106 | 109 | 110 |
| | performance | | | | |
| | Ability | 89 | 87 | 83 | 83 |
| | to achieve | | | | |
| | reduced fuel | | | | |
| | consumption | | | | |

The “discharge temperature” in TABLE 2 is the discharge temperature of the upper mixer and also the discharge temperature of the lower mixer in Comparative Examples 3 to 5 and Working Examples 1 to 7.

In Comparative Examples 3 to 5 and Working Examples 1 to 7, during kneading using the lower mixer, gas in the lower mixer was sucked using a suction device by way of the hole provided in the wall face of the channel between the lower mixer and the upper mixer.

The “injection of compressed air” in TABLE 2 refers to delivery of compressed air at 0.6 MPa and an expulsion rate of 950 L/min to the lower mixer by way of the hole formed in the wall face of the lower mixer. Note that this pressure is the value that was measured using the pressure gauge of the air hose attached to the tandem mixer. It should incidentally be noted that although the temperature of the compressed air was not measured, it is thought that this would have been a temperature in the vicinity of normal temperature.

By injecting compressed air into the lower mixer during kneading using the lower mixer, the wear resistance and the ability to achieve reduced fuel consumption were improved (see Comparative Example 3 and Working Example 1, Comparative Example 4 and Working Example 2, and Comparative Example 5 and Working Examples 3 to 7). In addition to this, it was also possible to improve wet braking performance. In addition, it was also possible to reduce Mooney viscosity.

### Comparative Example 6 and Working Examples 8 to 10

The raw materials and reagents that were used at these Examples are indicated below.
NR RSS #3
SBR “SBR 1502” manufactured by JSR Corporation
Solution polymerization SBR “Tuf 1834” manufactured by Asahi Kasei Corporation
Silica “Nipsil AQ” manufactured by Tosoh Silica Corporation
Silane coupling agent “Si 75” manufactured by Degussa
Stearic acid “LUNAC S-20” manufactured by Kao Corporation
Carbon black “N339 SEAST KH” manufactured by Tokai Carbon Co., Ltd.
Oil “PROCESS NC140” manufactured by ENEOS
Zinc oxide “Zinc Oxide No. 1” manufactured by Mitsui Mining & Smelting Co., Ltd.
Antioxidant “Antigen 6C” manufactured by manufactured by Sumitomo Chemical Co., Ltd.
Sulfur “5% Oil Treated Sulfur” manufactured by Tsurumi Chemical Industry Co., Ltd.
Vulcanization Accelerator 1 “Sanceler DM-G” manufactured by Sanshin Chemical Industry Co., Ltd.
Vulcanization Accelerator 2 “Soxinol CZ” manufactured by Sumitomo Chemical Co., Ltd.

TABLE 3

| | | First | |
|---|---|---|---|
| | | kneading | Final |
| | | stage | stage |
| Blending | NR | 20.0 | — |
| parts | SBR | 40.0 | — |
| by mass | Solution | 40.0 | — |
| | polymerization SBR | | |
| | Silica | 85.0 | — |
| | Silane coupling agent | 8.0 | — |
| | Stearic acid | 3.0 | — |
| | Carbon black | 10.0 | — |
| | Oil | 30.0 | — |
| | Zinc oxide | 2.0 | — |
| | Antioxidant | 2.0 | — |
| | Sulfur | — | 2.5 |
| | Vulcanization | — | 2.3 |
| | accelerator 1 | | |
| | Vulcanization | — | 1.9 |
| | accelerator 2 | | |

### Preparation of Unvulcanized Rubber in Comparative Example 6

The rubber components and compounding ingredients according to TABLE 3 were fed into a tandem mixer, kneaded using the upper mixer while PID control (specifically, PID control in which the control start temperature was 155° C., the target temperature was 155° C., and the control time was 40 seconds) was carried out, and kneaded using the lower mixer while PID control (specifically, PID control in which the control start temperature was 155° C., the target temperature was 155° C., and the control time was 200 seconds) was carried out, and the mixture was discharged (first kneading stage). The mixture obtained at the first kneading stage was rekneaded (second kneading stage). The mixture obtained at the second kneading stage and sulfur and a vulcanization accelerator were kneaded to obtain unvulcanized rubber (final stage).

### Preparation of Unvulcanized Rubber in Working Example 8

The rubber components and compounding ingredients according to TABLE 3 were fed into a tandem mixer, kneaded using the upper mixer while PID control (specifically, PID control in which the control start temperature was 155° C., the target temperature was 155° C., and the control time was 40 seconds) was carried out, and kneaded using the lower mixer while PID control (specifically, PID control in which the control start temperature was 155° C., the target temperature was 155° C., and the control time was 200 seconds) was carried out, and the mixture was discharged (first kneading stage). Regarding kneading using the lower mixer, compressed air generated by a compressor was delivered to the lower mixer by way of the hole formed in the wall face of the lower mixer from the start of control only for 20 seconds of the 200 seconds of control time. The mixture obtained at the first kneading stage was rekneaded (second kneading stage). The mixture obtained at the second kneading stage and sulfur and a vulcanization accelerator were kneaded to obtain unvulcanized rubber (final stage).

### Preparation of Unvulcanized Rubber in Working Example 9

Unvulcanized rubber was prepared in the same manner as in Working Example 8, except that compressed air was delivered to the lower mixer from the start of control only for 120 seconds of the 200 seconds of control time regarding kneading using the lower mixer.

### Preparation of Unvulcanized Rubber in Working Example 10

Unvulcanized rubber was prepared in the same manner as in Working Example 8, except that compressed air was delivered to the lower mixer throughout the 200 seconds of control time regarding kneading using the lower mixer.

### Preparation of Vulcanized Rubber

The unvulcanized rubber was vulcanized for 30 minutes at 150° C. to obtain vulcanized rubber.

### Evaluation

Mooney viscosity, wear resistance, wet braking performance, and ability to achieve reduced fuel consumption were measured in accordance with the foregoing methods. Mooney viscosities of the respective Examples are shown in TABLE 4 as indexed relative to a value of 100 for the Mooney viscosity obtained in Comparative Example 6. The smaller the index the lower the Mooney viscosity and the better the workability. Regarding wear resistance, the reciprocals of the amounts of wear for the respective Examples are shown in TABLE 4 as indexed relative to a value of 100 for the reciprocal of the amount of wear obtained in Comparative Example 6. The higher the index the better the wear resistance. Regarding wet braking performance, the reciprocals of the rebound resiliences for the respective Examples are shown in TABLE 4 as indexed relative to a value of 100 for the reciprocal of the rebound resilience obtained in Comparative Example 6. The higher the index the better the wet braking performance. tan δ of the respective Examples are shown in TABLE 4 as indexed relative to a value of 100 for the tan δ of Comparative Example 6. The smaller the index the lower the tan δ and the better the ability to achieve reduced fuel consumption.

TABLE 4

| | | Comparative | Working | Working | Working |
|---|---|---|---|---|---|
| | | Example 6 | Example 8 | Example 9 | Example 10 |
| First | Upper mixer target temperature ° C. | 155 | 155 | 155 | 155 |
| kneading | Lower mixer target temperature ° C. | 155 | 155 | 155 | 155 |
| stage | Upper mixer control time seconds | 40 | 40 | 40 | 40 |
| | Lower mixer control time seconds | 200 | 200 | 200 | 200 |
| | Compressed air injection | Absence | Presence | Presence | Presence |
| | Compressed air injection time seconds | — | 20 | 120 | 200 |
| | Discharge temperature ° C. | 160 | 160 | 160 | 160 |
| Second kneading stage (rekneading) | | Presence | Presence | Presence | Presence |
| Third kneading stage (rekneading) | | Absence | Absence | Absence | Absence |
| Evaluation | Mooney viscosity | 100 | 98 | 94 | 93 |
| | Wear resistance | 100 | 105 | 111 | 117 |
| | Wet braking performance | 100 | 102 | 104 | 105 |
| | Ability to achieve reduced fuel | 100 | 98 | 93 | 89 |
| | consumption | | | | |

The “discharge temperature” in TABLE 4 is the discharge temperature of the upper mixer and also the discharge temperature of the lower mixer.

In Comparative Example 6 and Working Examples 8 to 10, during kneading using the lower mixer, gas in the lower mixer was sucked using a suction device by way of the hole provided in the wall face of the channel between the lower mixer and the upper mixer.

The “injection of compressed air” in TABLE 4 refers to delivery of compressed air at 0.6 MPa and an expulsion rate of 950 L/min to the lower mixer by way of the hole formed in the wall face of the lower mixer. Note that this pressure is the value that was measured using the pressure gauge of the air hose attached to the tandem mixer. It should incidentally be noted that although the temperature of the compressed air was not measured, it is thought that this would have been a temperature in the vicinity of normal temperature.

By injecting compressed air into the lower mixer during kneading using the lower mixer, the wear resistance and the ability to achieve reduced fuel consumption were improved (see Comparative Example 6 and Working Examples 8 to 10). In addition to this, it was also possible to improve wet braking performance. In addition, it was also possible to reduce Mooney viscosity.

What is claimed is:

1. A rubber composition manufacturing method comprising:
an operation in which at least a rubber component, silica, and a silane coupling agent are fed into a kneader including a first kneading chamber, a first rotor rotatable in the first kneading chamber, a second kneading chamber downstream of the first kneading chamber, and a second rotor rotatable in the second kneading chamber and kneaded in the first kneading chamber; and
an operation in which a first mixture formed by the operation in which kneading is performed in the first kneading chamber is transferred to the second kneading chamber and kneaded in the second kneading chamber, wherein
compressed gas is delivered to the second kneading chamber in the operation in which kneading is performed in the second kneading chamber.

2. The rubber composition manufacturing method according to claim 1, wherein
the kneader further includes a hole constituting an opening in a wall face of the second kneading chamber, and
the compressed gas is delivered to the second kneading chamber by way of the hole of the second kneading chamber when the compressed gas is delivered to the second kneading chamber.

3. The rubber composition manufacturing method according to claim 1, wherein
the kneader further includes a hole constituting an opening in a wall face of a channel between the first kneading chamber and the second kneading chamber, and
gas in the second kneading chamber is discharged at least by way of the hole of the channel at least while the compressed gas is delivered to the second kneading chamber.

4. The rubber composition manufacturing method according to claim 1, wherein the compressed gas is compressed air.

5. The rubber composition manufacturing method according to claim 1, wherein proportional integral differential control of a rotational speed of the second rotor is performed to set a kneading temperature in the second kneading chamber to a target temperature in the operation in which kneading is performed in the second kneading chamber.

6. The rubber composition manufacturing method according to claim 5, wherein the target temperature is 140° C. or more.

7. The rubber composition manufacturing method according to claim 5, wherein the target temperature is 145° C. or more.

8. The rubber composition manufacturing method according to claim 1, wherein proportional integral differential control of a rotational speed of the first rotor is performed to set a kneading temperature in the first kneading chamber to a target temperature in the operation in which kneading is performed in the first kneading chamber.

9. The rubber composition manufacturing method according to claim 8, wherein the target temperature is 140° C. or more.

10. The rubber composition manufacturing method according to claim 8, wherein the target temperature is 145° C. or more.

11. The rubber composition manufacturing method according to claim 1, wherein
proportional integral differential control of a rotational speed of the first rotor is performed to set a kneading temperature in the first kneading chamber to a target temperature in the operation in which kneading is performed in the first kneading chamber,
the target temperature is 140° C. or more in the operation in which kneading is performed in the first kneading chamber,
proportional integral differential control of a rotational speed of the second rotor is performed to set a kneading temperature in the second kneading chamber to a target temperature in the operation in which kneading is performed in the second kneading chamber, and
the target temperature is 140° C. or more in the operation in which kneading is performed in the second kneading chamber.

12. The rubber composition manufacturing method according to claim 11, wherein
the target temperature is 145° C. or more in the operation in which kneading is performed in the first kneading chamber, and
the target temperature is 145° C. or more in the operation in which kneading is performed in the second kneading chamber.

13. The rubber composition manufacturing method according to claim 11, wherein
the proportional integral differential control is carried out for 10 seconds or more in the operation in which kneading is performed in the first kneading chamber, and
the proportional integral differential control is carried out for 30 seconds or more in the operation in which kneading is performed in the second kneading chamber.

14. The rubber composition manufacturing method according to claim 13, wherein the proportional integral differential control is carried out for 30 seconds or more in the operation in which kneading is performed in the first kneading chamber.

15. The rubber composition manufacturing method according to claim 13, wherein the proportional integral differential control is carried out for 120 seconds or more in the operation in which kneading is performed in the second kneading chamber.

16. The rubber composition manufacturing method according to claim 1, wherein the rubber component includes natural rubber and styrene-butadiene rubber.

17. A tire manufacturing method comprising:
an operation in which the rubber composition manufacturing method according to claim 1 is used to prepare a rubber composition; and
an operation in which the rubber composition is used to fabricate an unvulcanized tire.

18. The tire manufacturing method according to claim 17, wherein the operation in which the unvulcanized tire is fabricated includes fabrication of a tire member that includes the rubber composition and fabrication of the unvulcanized tire that includes the tire member.

19. The tire manufacturing method according to claim 17, further comprising an operation in which the unvulcanized tire is vulcanized and molded.

20. A rubber composition manufacturing apparatus comprising:
a kneader including a first kneading chamber, a first rotor rotatable in the first kneading chamber, a second kneading chamber downstream of the first kneading chamber, a second rotor rotatable in the second kneading chamber, and a hole constituting an opening in a wall face of the second kneading chamber; and
a compressor that generates compressed gas to be delivered to the second kneading chamber through the hole of the second kneading chamber.
